(19) United States
(12) Patent Application Publication
(10) Pub. No.: US 2026/0146902 A1
(43) Pub. Date: May 28, 2026

(54) FLEXIBLE THREE-DIMENSIONAL (3D) PRESSURE SENSING DEVICE

(71) Applicant: WUYI UNIVERSITY, Jiangmen (CN)

(72) Inventors: Fei WANG, Jiangmen (CN); Youliang LV, Jiangmen (CN); Jun LI, Jiangmen (CN)

(21) Appl. No.: 19/262,419

(22) Filed: Jul. 8, 2025

(30) Foreign Application Priority Data
Nov. 26, 2024 (CN) 202411702521.1

(51) Int. Cl. G01L 1/18

(52) U.S. Cl. CPC G01L 1/18

(57) ABSTRACT

A flexible three-dimensional (3D) pressure sensing device includes a force-sensitive component composed of a single piece of flexible and electrically conductive material with piezoresistive properties, a plurality of 3D transmission components distributed on a surface of the force-sensitive component, and a plurality of electrodes arranged on a periphery of the force-sensitive component. The 3D transmission components are configured to transmit pressure to the force-sensitive component, causing characteristic corresponding changes in electrical resistance of the force-sensitive component, the pressure including a normal pressure and shear pressure. The plurality of the electrodes are configured to lead out resistance distribution data of the force-sensitive component through wires, so that a backend circuit device calculates 3D pressure distribution information of the flexible 3D pressure sensing device at each position on the surface at each time point based on the resistance distribution data.

### CROSS-REFERENCE TO RELATED APPLICATION

This application is based on and claims the benefit of priority from Chinese Patent Application No. 2024117025211, filed on November 26, 2024, the entirety of which is incorporated by reference herein.

### TECHNICAL FIELD

Embodiments of the present disclosure relate to, but are not limited to, the field of pressure sensing technologies, and in particular, to a flexible three-dimensional (3D) pressure sensing device.

### BACKGROUND

In the current era marked by booming development of emerging technologies such as the Internet of Things (IoT), metaverse, smart home and furniture, humanoid robots, and flexible robots, there is an increasingly urgent demand for pressure measurement technologies in human-machine interfaces. These industries require device interfaces to accurately capture pressure changes from users or environmental interfaces, aiming to achieve more natural, safe, and intelligent interactive experiences. For instance, if humanoid robots could be equipped with electronic skin, i.e. tactile sensing capabilities akin to human skin, their interaction abilities with both environments and humans would be significantly enhanced. Existing flexible tactile sensors, such as linear piezoresistive or array-type tactile sensors, face challenges including complex manufacturing processes, high costs, and limited sensing functionalities. Moreover, these sensors often fail to achieve multi-dimensional pressure detection when detecting touch positions and magnitudes of forces and overall morphology inferred from forces, significantly limiting their application scope.

Traditional pressure monitoring technologies, which employ pressure sensor matrixes for measurement, exhibit notable limitations. Each sensor element requires independent wire connections, resulting in an excessive number of wires in sensor matrixes, which not only increases device complexity and costs but also compromises device flexibility, stretchability, and conformability to complex surfaces. When upgrading each sensor element in a pressure sensor matrix to a 3D pressure sensor, the number of wires per sensor element increases from two to six or even more, further exacerbating device complexity and cost issues. This severely restricts device flexibility and practical application scenarios.

### SUMMARY

The following is a summary of the subject matters described in detail herein. This summary is not intended to limit the scope of protection of the claims.

Embodiments of the present disclosure provide a flexible 3D pressure sensing device with a simple structure, made entirely of flexible materials, requiring only the arrangement of electrodes and wires on the periphery, while having no internal wires, and having good conformity to curved shapes, thereby improving 3D perception capabilities, simplifying device structure, reducing manufacturing difficulty and costs, enhancing device flexibility, and expanding the range of applicable scenarios for the device.

According to an embodiment of a first aspect of the present disclosure, there is provided a flexible three-dimensional (3D) pressure sensing device, including: a force-sensitive component, a plurality of 3D transmission components, and a plurality of electrodes, where the force-sensitive component is composed of a single piece of flexible and electrically conductive material with a piezoresistive property; the plurality of the 3D transmission components are distributed on a surface of the force-sensitive component, and each of the plurality of 3D transmission components is configured to transmit pressure to the force-sensitive component, causing corresponding characteristic changes in electrical resistance of the force-sensitive component, where the pressure includes a normal pressure and a shear pressure; and the plurality of the electrodes are arranged on a periphery of the force-sensitive component, and each of the plurality of electrodes is configured to lead out resistance distribution data of the force-sensitive component through a respective wire, such that that a backend circuit device calculates 3D pressure distribution information of the flexible 3D pressure sensing device at each position on the surface at each time point based on the resistance distribution data.

In some embodiments, the force-sensitive component is a solid planar structure or a porous mesh structure.

In some embodiments, the force-sensitive component is made of an electrically conductive composite material, or a liquid metal, or a conductor or semiconductor material rich in a conductive ion, or an assembly of electrically conductive fibers with a piezoresistive property, or an elastomer and an assembly of fibers containing intrinsically conductive polymers.

In some embodiments, each of the plurality of 3D transmission components has a respective 3D protruding structure, and the plurality of 3D transmission components are uniformly or non-uniformly distributed on the surface of the force-sensitive component, with each 3D transmission component being intimately bonded to the force-sensitive component.

In some embodiments, each of the plurality of electrodes is formed by a coating or plating of a good conductor of electricity, or a micro-nano structured material, or a carbon-based electrically conductive material, or an intrinsically conductive polymer, or a liquid metal, or is an electrically conductive fiber material, with the plurality of electrodes being uniformly or non-uniformly arranged on the periphery of the force-sensitive component.

In some embodiments, an elastic modulus of the material of each of the plurality of 3D transmission components is greater than or equal to that of the force-sensitive component.

In some embodiments, chemical bonds are formed at an interface between each of the plurality of 3D transmission components and the force-sensitive component.

In some embodiments, when materials used for each of the plurality of 3D transmission components and the force-sensitive component are the same, a method of template injection molding or mold imprinting is employed to form a sheet-like elastic electrically conductive material with 3D protruding structures, and the plurality of electrodes and the respective wire are printed at designated positions on the periphery of the force-sensitive component.

In some embodiments, when materials used for at least one of the plurality of 3D transmission components and the force-sensitive component are different, the force-sensitive component is cut or processed to a required size and shape, and fixing of the at least one of the plurality of 3D transmission components to the surface of the force-sensitive component is carried out.

In some embodiments, the fixing is carried out by: applying a transmission material to designated positions of the plurality of 3D transmission components via a glue dispensing machine to form the plurality of 3D transmission components, or preparing the plurality of 3D transmission components on the surface of the force-sensitive component via 3D printing technology, or applying each unit of an additional mechanical transmission part to the designated positions on the surface of the force-sensitive component through textile and garment processing techniques.

In some embodiments, a surface of at least one of the plurality of 3D transmission components is covered with an encapsulation layer, and encapsulation material of the encapsulation layer is a flexible polymer elastomer with a low elastic modulus.

A flexible 3D pressure sensing device according to an embodiment of the present disclosure includes: a force-sensitive component, a plurality of 3D transmission components, and a plurality of electrodes, where the force-sensitive component is composed of a single piece of flexible and electrically conductive material with piezoresistive properties; the plurality of 3D transmission components are distributed on a surface of the force-sensitive component, and the 3D transmission components are configured to transmit pressure to the force-sensitive component, causing corresponding characteristic changes in electrical resistance of the force-sensitive component, where the pressure includes a normal pressure and a shear pressure; and the plurality of electrodes are arranged on a periphery of the force-sensitive component, and the electrodes are configured to lead out resistance distribution data of the force-sensitive component through their respective wires, so that a backend circuit device calculates 3D pressure distribution information of the flexible 3D pressure sensing device at each position on the surface at each time point based on the resistance distribution data. The embodiment of the present disclosure uses a flexible and electrically conductive material to form the force-sensitive component, which has piezoresistive properties, meaning that its resistance changes when subjected to compression or stretching. Therefore, planar data of resistance distribution can be constructed through this flexible and electrically conductive material. A plurality of 3D transmission components are distributed on the surface of the flexible and electrically conductive material, and the 3D transmission components can transmit pressure to the force-sensitive component, ensuring that both normal pressure and shear pressure can be transmitted. A plurality of electrodes are arranged on the periphery of the flexible and electrically conductive material, and the electrodes are configured to connect wires to output signals. The method of electrical impedance tomography can be employed to read resistance distribution data inside the flexible and electrically conductive material in real time. Based on the resistance distribution data, 3D pressure distribution at various positions on the plane formed by all the 3D transmission components can be determined, thereby realizing a fully flexible, internally electrode-free or partially electrode-based, electrical impedance tomography-enabled, multi-point simultaneous detection flexible 3D pressure sensing device, which functions as an equivalent to a 3D pressure sensor matrix. Based on this, the flexible 3D pressure sensing device of the present disclosure has the advantages of a simple structure, being made entirely of flexible materials, requiring only the arrangement of electrodes and wires on the periphery, while having no internal wires, and having good conformity to curved shapes, and can improve 3D perception capabilities, simplify device structure, reduce manufacturing difficulty and costs, enhance device flexibility, and expand the range of applicable scenarios for the device.

Additional features and advantages of the present disclosure will be set forth in the subsequent description, and in part will become apparent from the description, or may be learned by practice of the present disclosure. The objectives and other advantages of the present disclosure can be realized and obtained by structures specified in the description, the claims and the accompanying drawings.

### BRIEF DESCRIPTION OF DRAWINGS

The accompanying drawings are used to facilitate further understanding of the technical schemes of the present disclosure and constitute a part of the description to explain the technical schemes of the present disclosure together with the embodiments of the present disclosure, and do not constitute a restriction on the technical schemes of the present disclosure.

FIG. 1A is a schematic diagram of a top view of a flexible 3D pressure sensing device according to an embodiment of the present disclosure;

FIG. 1B is a schematic diagram of a cross-section taken along the dashed line in the top view of FIG. 1A;

FIG. 2 is a schematic diagram of a cross-section of a flexible 3D pressure sensing device after encapsulation according to another embodiment of the present disclosure;

FIG. 3A is a schematic diagram of a top view of a flexible 3D pressure sensing device according to another embodiment of the present disclosure;

FIG. 3B is a schematic diagram of a cross-section taken along the dashed line in the top view of FIG. 3A; and

FIG. 4 is a schematic diagram of a cross-section of a flexible 3D pressure sensing device after encapsulation according to another embodiment of the present disclosure.

### DETAILED DESCRIPTION

In order to make the objectives, technical schemes and advantages of the present disclosure clearer, the present disclosure is further described in detail in conjunction with the accompanying drawings and embodiments. It should be understood that the specific embodiments described here are only intended to explain the present disclosure and are not intended to limit the present disclosure.

It should be known that, in the description of the embodiments of the present disclosure, “a plurality of (or multiple)” means two or more; “greater than”, “less than”, “over”, etc. are to be understood to exclude the given figure; and “above”, “below”, “within”, etc. are understood to include the given figure. If there are descriptions using “first”, “second”, etc., they are only for the purpose of distinguishing technical features, and should not be understood as indicating or implying relative importance or implying the number of the indicated technical features or implying the sequence of the indicated technical features.

In the current era marked by booming development of emerging technologies such as the Internet of Things (IoT), metaverse, smart home and furniture, humanoid robots, and flexible robots, there is an increasingly urgent demand for pressure measurement technologies in human-machine interfaces. These industries require device interfaces to accurately capture pressure changes from users or environmental interfaces, aiming to achieve more natural, safe, and intelligent interactive experiences. For instance, if humanoid robots could be equipped with electronic skin, i.e. tactile sensing capabilities akin to human skin, their interaction abilities with both environments and humans would be significantly enhanced. Existing flexible tactile sensors, such as linear piezoresistive or array-type tactile sensors, face challenges including complex manufacturing processes, high costs, and limited sensing functionalities. Moreover, these sensors often fail to achieve multi-dimensional pressure detection when detecting touch positions and magnitudes of forces and overall morphology inferred from forces, significantly limiting their application scope.

Traditional pressure monitoring technologies, which employ pressure sensor matrixes for measurement, exhibit notable limitations. Each sensor element requires independent wire connections, resulting in an excessive number of wires in sensor matrixes, which not only increases device complexity and costs but also compromises device flexibility, stretchability, and conformability to complex surfaces. When upgrading each sensor element in a pressure sensor matrix to a 3D pressure sensor, the number of wires per sensor increases from two to six or even more, further exacerbating device complexity and cost issues. This severely restricts device flexibility and practical application scenarios.

To solve the above technical problem, an embodiment of the present disclosure provides a flexible three-dimensional (3D) pressure sensing device, including: a force-sensitive component, 3D transmission components, and electrodes, where the force-sensitive component is composed of a single piece of flexible and electrically conductive material with piezoresistive properties; a plurality of the 3D transmission components are distributed on a surface of the force-sensitive component, and the 3D transmission components are configured to transmit pressure to the force-sensitive component, causing characteristic corresponding changes in electrical resistance of the force-sensitive component. The pressure includes normal pressure and shear pressure. A plurality of the electrodes are arranged on a periphery of the force-sensitive component, and the electrodes are configured to lead out resistance distribution data of the force-sensitive component through wires, such that a backend circuit device calculates 3D pressure distribution information of the flexible 3D pressure sensing device at each position on the surface at each time point based on the resistance distribution data. The embodiment of the present disclosure uses a flexible and electrically conductive material to form the force-sensitive component, and the flexible and electrically conductive material has piezoresistive properties, meaning that its resistance changes when the material is subjected to compression or stretching. Therefore, planar data of resistance distribution can be constructed through the flexible and electrically conductive material. A plurality of 3D transmission components are distributed on the surface of the flexible and electrically conductive material, and the 3D transmission components can transmit pressure to the force-sensitive component, ensuring that both normal pressure and shear pressure can be transmitted. A plurality of electrodes are arranged on the periphery of the flexible and electrically conductive material, and the electrodes are configured to connect wires to output signals. The method of electrical impedance tomography can be employed to read resistance distribution data inside the flexible and electrically conductive material in real time. Based on the resistance distribution data, 3D pressure distribution at various positions on the plane formed by all the 3D transmission components can be determined, thereby realizing a flexible 3D pressure sensing device with a fully flexible, internally electrode-free or partially electrode-based, electrical impedance tomography-enabled, multi-point simultaneous detection, which functionally equivalents to a 3D pressure sensor matrix. Based on this, the flexible 3D pressure sensing device of the present disclosure has the advantages of a simple structure, being made entirely of flexible materials, requiring only the arrangement of electrodes and wires on the periphery, while having no internal wires, and having good conformity to curved shapes, and can improve 3D perception capabilities, simplify device structure, reduce manufacturing difficulty and costs, enhance device flexibility, and expand the range of applicable scenarios for the device.

The flexible 3D pressure sensing device of the present disclosure includes three parts, including: a force-sensitive component, 3D transmission components, and electrodes.

It can be understood that the force-sensitive component is composed of a single piece of flexible and electrically conductive material, typically in a solid planar layer structure, but it may also be in a mesh structure, which contains holes in part. The flexible and electrically conductive material can produce changes in resistance at corresponding positions when pressed, that is, it has force-sensitive properties, or piezoresistive properties. Alternatively, the material may not be a conventional piezoresistive material, but can be any material as long as the resistance at the pressed position changes in a predictable manner when pressure is applied.

It can be understood that the 3D transmission components transmit 3D pressure to the force-sensitive component, causing characteristic corresponding changes in the resistance of the force-sensitive component; and the electrodes are arranged on the periphery of the entire device, enabling real-time monitoring of the resistance distribution of the force-sensitive component through electrical impedance tomography, thereby calculating the 3D pressure distribution information at each position on the surface of the device at each moment.

It can be understood that the 3D transmission components are a series of 3D protruding structures, which can be hemispherical, cubic, pyramidal, triangular prism, or artistic shapes, etc. The 3D protruding structures can be regarded as 3D protruding units, and each 3D protruding unit of the 3D transmission components is uniformly or non-uniformly distributed on the surface of the force-sensitive component. Since the 3D transmission components and the force-sensitive component are tightly bonded together, each three-dimensional unit of the 3D transmission components can effectively transmit the normal pressure and shear forces beared to the force-sensitive component.

It can be understood that electrodes can be uniformly arranged on the periphery of the entire device, with equal spacing between electrodes. Alternatively, the density of the distribution of electrodes can be adjusted according to the requirements for resolution and accuracy at different positions. In addition to arranging electrodes on the periphery, electrodes can also be selectively arranged at different positions beneath the force-sensitive material, significantly improving the measurement accuracy of the sensor regarding position and pressure.

In some embodiments, the force-sensitive component is made of electrically conductive composite materials. In some implementations, in order to enhance piezoresistive properties, the resistance of the conductive material is in the semiconductor range. In some implementations, pressure-sensitive rubber, graphene-silicone composite materials, carbon nanotube polyurethane composite materials, and/or the like can be used. In some other implementations, the material of the force-sensitive component can also be conductor or semiconductor materials with a certain degree of fluidity, such as a gallium-indium alloy or a liquid rich in conductive ions. The material of the force-sensitive component can also be an assembly of electrically conductive fibers with piezoresistive properties, such as pure cotton knitted fabrics with graphene and carbon nanotubes attached to the surface, or a spandex warp-knitted mesh fully coated with carbon black polyurethane composite material prepared by screen printing. In some implementations, the material of the force-sensitive component can also be an elastomer containing intrinsically conductive polymers, such as a composite film of polypyrrole and polyurethane. Finally, as long as the selected material is an elastic, continuously conductive sheet-like mesoporous or solid material, and satisfies the condition where the resistance at the compressed position changes in a predictable manner under pressure is applied, the usage requirements of the force-sensitive component of the embodiments of the present disclosure are met.

It can be understood that the material of the 3D transmission components can be exactly the same as that of the force-sensitive components, or it can be another conductor material, semiconductor material, or insulating material. The 3D transmission components are typically solid structures. In some embodiments, in order to achieve effective pressure transmission, the elastic modulus of the material of the 3D transmission components is greater than or equal to the elastic modulus of the material of the force-sensitive component. Additionally, the 3D transmission components need to be intimately bonded to the force-sensitive component, preferably forming chemical bonds between the interfaces of the two, such as creating polymer cross-linking, etc., to ensure long-term stability and robustness of the structure of the device.

It can be understood that the material of the electrode part can be a coating or plating of a good conductor of electricity such as gold, silver, or copper, or a micro-nano structured material (such as silver nanowires/silicone composite materials, or silver powder particles/epoxy resin composite materials), or a carbon-based electrically conductive material (such as carbon fibers), or an intrinsically conductive polymer (such as poly(3,4-ethylenedioxythiophene)-polystyrene sulfonate), or liquid metal (such as gallium-indium alloy), or electrically conductive fiber material.

It can be understood that in the case where the materials of the 3D transmission components and the force-sensitive component are the same, methods such as template injection molding or mold imprinting can be used to form a sheet-like elastic conductive material with 3D transmission structural units. Subsequently, electrode materials can be printed (such as by screen printing, chemical vapor deposition, physical vapor deposition, and magnetron sputtering), or conductive electrode materials (such as applying silver paste resin) may be pasted, or wires (such as silver-plated nylon yarn) may be embroidered, or conductive sewing threads may be sewn, uniformly or non-uniformly on the periphery of the device at designated electrode positions. Finally, the electrodes are connected with wires to connect the device to the backend circuit device.

It can be understood that in the case where the materials of the 3D transmission components and the force-sensitive component are different, the force-sensitive component is first cut or processed to the required size and shape, and then the transmission components are fixed to the surface of the force-sensitive component. The transmission materials can be applied to designated positions of the 3D protruding units using a glue dispensing machine to form the 3D transmission components, or 3D printing technology can be utilized to prepare the 3D transmission components on the surface of the force-sensitive component, or through textile and garment processing methods, each unit of the additional mechanical transmission part, such as sewing buttons (the button serving as the pressure transmission part) or other small ornaments, and/or the like, can be applied to corresponding positions on the surface of the force-sensitive component.

It can be understood that the surface part of the 3D transmission components may be partially or fully covered with an encapsulation layer. In some embodiments, the encapsulation material of the encapsulation layer is a flexible polymer elastomer with a relatively low elastic modulus, thereby ensuring that the pressure on each part can generate stress concentration near the transmission units, ensuring that the pressure can reach the 3D transmission components from the surface, and the 3D transmission components can accurately and repeatedly transmit the 3D pressure to the corresponding positions of the force-sensitive component.

It can be understood that since the force-sensitive component is the base of the entire device, when the force-sensitive component has good elasticity in three dimensions, the device can not only achieve dynamic monitoring of 3D pressure in its original planar state but can also conform well to various 3D shapes (such as spherical shapes, conforming to a human-like head of a humanoid robot). During the conforming process, the device partially undergoes stretching, and after calibration, the conforming device can also provide real-time monitoring of multi-point 3D forces.

It can be understood that the piezoresistive characteristics of the force-sensitive component determine the sensitivity of the device in 3D pressure detection, and when other conditions remain unchanged, the more pronounced the piezoresistive properties of the force-sensitive material, the higher the sensitivity of the device. The size and stiffness of the 3D transmission components also partially determine the measurement range and sensitivity of the device in 3D pressure detection. When other conditions remain unchanged, a greater stiffness at the same size leads to a more pronounced stress concentration on the force-sensitive component, resulting in higher sensitivity, while possibly reducing the measurement range of the force. Similarly, different shapes and sizes of the 3D transmission components can also cause varying stress concentration effects, leading to different sensitivities in 3D force measurement and different measurement ranges. Additionally, the number, distribution, and density of the 3D protruding units of the 3D transmission components also partially determine the number of measurable points, the distribution of measurable points, and the measurement density in 3D force measurement.

It can be understood that with the same backend circuit device and algorithm, the distribution, position, and number of electrodes predominantly determine the magnitude of error and precision of pressure-measurable positions, which also affect the accuracy of pressure measurement. For instance, when the number of electrodes increases, the resistance distribution obtained during electrical impedance tomography analysis becomes more detailed, thereby enhancing the accuracy of normal pressure measurement and reducing position recognition error, while also improving the accuracy of shear force measurement. When electrodes are not only distributed along the periphery but also uniformly or non-uniformly arranged on the back of the force-sensitive component, the accuracy of resistance acquisition in electrical impedance tomography analysis can be further improved, thereby improving the positional accuracy and pressure accuracy of the device in 3D pressure detection.

In view of this, the flexible 3D pressure sensing device of the present disclosure is mainly composed of elastic materials and is divided into three parts according to function: the force-sensitive component, the 3D transmission components, and the electrodes. The force-sensitive component is made from a single piece of flexible and electrically conductive material that has piezoresistive properties, meaning its resistance changes under compression and stretch. Therefore, planar data of resistance distribution can be constructed through this flexible and electrically conductive material. On the surface of the flexible and electrically conductive material, there are distributed 3D transmission components formed from the same or different materials, which can transmit pressure to the force-sensitive component, ensuring that both normal pressure and shear pressure can be transmitted. A plurality of electrodes are arranged on the periphery of the flexible and electrically conductive material, and the electrodes are configured to connect wires to output signals. The method of electrical impedance tomography can be employed to read resistance data inside the flexible and electrically conductive material in real time. Based on the resistance distribution data, the 3D pressure distribution at various positions on the plane formed by all the protruding structures can be determined, thereby realizing a fully flexible, internally electrode-free or partially electrode-based, electrical impedance tomography-enabled, multi-point simultaneous detection 3D pressure touch sensing device, which functions as an equivalent to a 3D pressure sensor matrix.

In summary, the embodiments of the present disclosure provide a 3D pressure sensing device with a simple structure, made entirely of flexible materials, requiring only peripheral electrodes and wires, and having no internal wires, while also exhibiting good conformity to curved shapes, which has the following advantages:

(1) The device is a fully flexible pressure sensing device with 3D protruding structures, which can measure pressure not only in the Z direction (normal) but also in the XY plane, thus measuring shear force in an in-plane direction, demonstrating significant advantages in 3D force sensing.

(2) Multi-point real-time touch control is achieved across the entire touch area, ensuring that the touch at each protruding point is 3D pressure, rather than a single point of 3D pressure.

(3) The use of electrical impedance tomography technology minimizes the number of electrodes and wires within the touch area.

(4) The device has a simple structure, low costs, and is easy to process, while also exhibits excellent stability and robustness. Especially compared to existing technologies, the device provided by the present disclosure greatly simplifies the device structure and enhances stability and durability.

The embodiments of the present disclosure will be further explained below with reference to the accompanying drawings.

### Embodiment I

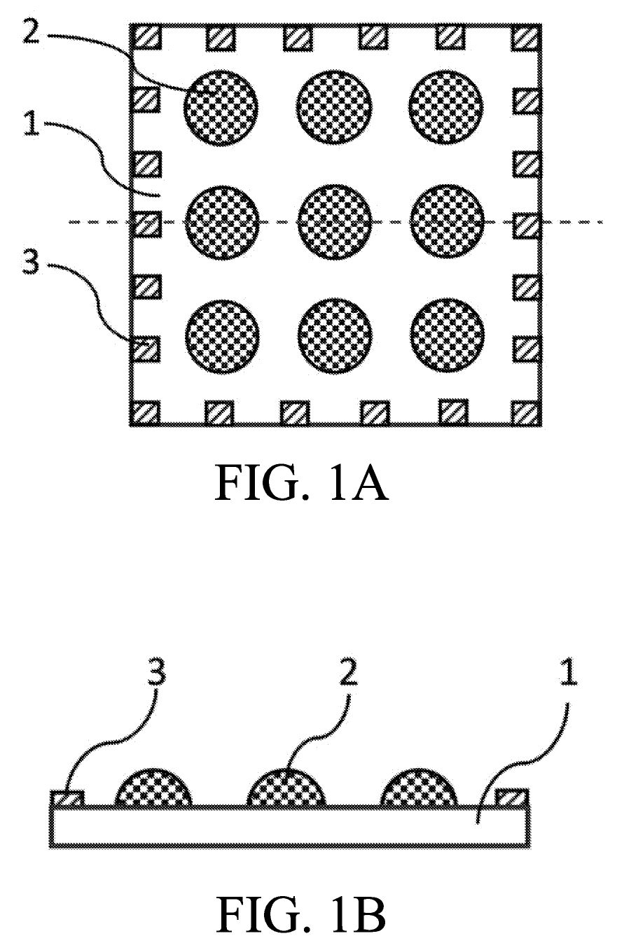

Referring to FIGS. 1A and 1B, this embodiment provides a flexible 3D pressure sensing device, which includes three parts: a force-sensitive component 1, 3D transmission components 2, and electrodes 3. The force-sensitive component 1 is a layer of silicone rubber filled with graphene and carbon nanotubes. Due to the presence of the filling particles, the force-sensitive component 1 exhibits a piezoresistive effect. The 3D transmission components 2 are hemispherical 3D protruding structures made of pure silicone rubber, which can be prepared on the surface of the force-sensitive component 1 using a glue dispensing machine or 3D printing. FIGS. 1A and 1B only show a matrix of protruding structures forming the 3D transmission components 2, and the number of protruding structures can be adjusted according to requirements. Since both the force-sensitive component 1 and the 3D transmission components 2 contain silicone rubber, they can be tightly bonded to each other. As the 3D transmission components 2 are elastic 3D structures rather than planar structures, both normal pressure and tangential (shear) pressure can be effectively transmitted. Additionally, because the 3D transmission components 2 are made of silicone rubber, they can serve as an insulator, preventing external conductors (such as the human body) from making direct electrical contact with the force-sensitive component 1, thus avoiding noise or reducing the accuracy of the device. The electrodes 3 are a composite material of silver nanowires and silicone, which can be formed by applying a dispersion of silver nanowires in ethanol and then applying a certain amount of silicone after the ethanol evaporates. The electrodes 3 also contain silicone rubber and thus can also be bonded effectively with the force-sensitive component 1. Moreover, the silver nanowires in the electrodes 3 can establish effective electrical connections with the force-sensitive component 1.

Since the force-sensitive component 1 exhibits piezoresistive properties, meaning its resistance changes when subjected to pressure, the force-sensitive component 1 can provide resistance distribution data for the entire area across the device. In some embodiments, the 3D transmission components 2 have a larger elastic modulus than the force-sensitive component 1, effectively transmitting normal and tangential pressures to the force-sensitive component 1, causing corresponding changes in resistance. When external pressure or tangential force is applied to any one or more protruding structures of the 3D transmission components 2, specific planar resistance distribution characteristics will be caused in the force-sensitive component 1. At this time, by sequentially applying current to the surrounding electrodes and measuring the voltage distribution of other electrodes, the method of electrical impedance tomography can be used to read the resistance distribution of the force-sensitive component 1 in real time. Then, based on this resistance distribution data, the 3D pressure distribution at various positions on the surface of the device can be inferred, specifically the distribution data of the pressure and shear force borne by the 3D transmission components 2. This enables the realization of a fully flexible, internally electrode-free or partially electrode-based, electrical impedance tomography-enabled, multi-point simultaneous detection 3D pressure sensing device.

The device only arranges electrodes on the periphery, effectively reducing the large number of wires required by traditional 3D pressure sensor matrixes. Moreover, if an overall stretchable flexible device is to be made based on a traditional 3D pressure sensor matrix, stretchable wire technology will also be required. Therefore, Embodiment I can also avoid the need for stretchable wire technology, thus possessing high practicality. Furthermore, Embodiment I can achieve real-time monitoring of 3D pressure at multiple points within a plane, which has significant advantages over inductive or capacitive pressure touch panels that can only identify finger positions. Additionally, compared to the single normal pressure measurement function of electrical impedance tomography, it can provide the distribution of shear forces at multiple points, thus demonstrating inventiveness.

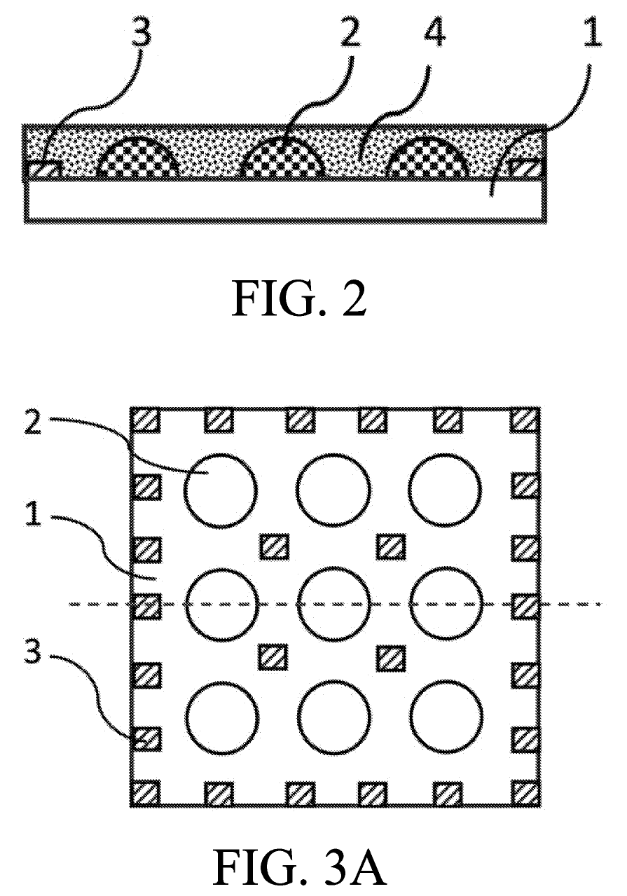

Referring to FIG. 2, this embodiment can also add an optional encapsulation layer 4 on the basis of the aforementioned device, which involves pouring silicone over the entire surface of the device to make the surface of the device flat. In some embodiments, the elastic modulus of the silicone rubber used for encapsulation layer 4 should be lower than that of the 3D transmission components 2, ensuring that the normal pressure and lateral shear forces at each position on the surface of the device after encapsulation can be effectively transmitted to the corresponding protruding positions of the 3D transmission components 2.

### Embodiment II

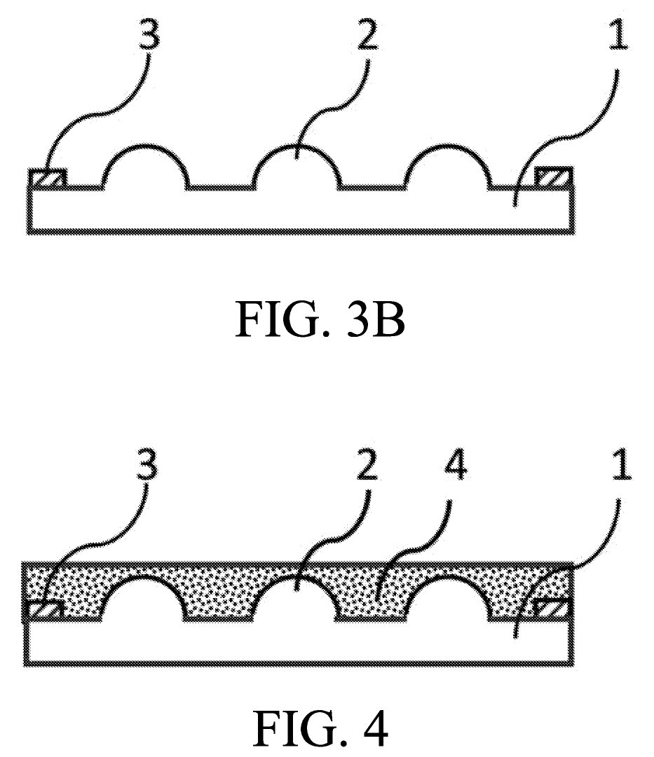

Referring to FIGS. 3A and 3B, this embodiment provides a flexible 3D pressure sensing device, which includes three parts: a force-sensitive component 1, 3D transmission components 2, and electrodes 3. This embodiment differs from Embodiment I in that, the force-sensitive component 1 and the 3D transmission components 2 are made from the same material, allowing for a one-step preparation process, thus simplifying the manufacturing process. The preferred material and processing method involve injecting a polyurethane and graphene composite material to form the structure shown in FIG. 2, which has nine semicircular protrusions on a flat plate, with the plate and protrusions being an integrated structure. Conductive adhesive made of silver powder/epoxy resin is coated on the electrode positions shown in FIG. 2, so that the electrodes 3 are set not only along the perimeter, but also at inner positions beneath the force-sensitive part.

By adopting this method, the 3D transmission components 2 themselves are also conductive and have a certain piezoresistive effect, thus the force-sensitive component 1 and the 3D transmission components 2 together form a piezoresistive composite material. When the protruding parts are subjected to pressure and shear forces, the magnitudes and directions of the forces exhibit a one-to-one correspondence with resistance distributions across the piezoresistive material composite. In this way, through the method of electrical impedance tomography, it is possible to measure the resistance distribution in real time, thereby inferring the magnitude and direction of the forces at various positions on the surface of the device. This enables the realization of a fully flexible, internally partially electrode-based, electrical impedance tomography-enabled, multi-point simultaneous detection 3D pressure sensing device.

Referring to FIG. 4, this embodiment can also add an optional encapsulation layer 4 on the basis of the aforementioned device, which involves pouring and preparing a polyurethane encapsulation layer over the entire surface of the device to make the surface of the device flat. In some embodiments, the elastic modulus of the silicone rubber used for the encapsulation layer 4 should be lower than that of the 3D transmission components 2, ensuring that the normal pressure and lateral shear forces at each position on the surface of the device after encapsulation can be effectively transmitted to the corresponding protruding positions of the 3D transmission components 2. Since the encapsulation layer 4 is made of insulating material, it can serve to insulate the device, preventing human contact with the piezoresistive composite body, thus avoiding electric shock, noise, and reduced accuracy.

### Embodiment III

Referring to the top view of FIGS. 1A and 1B, this embodiment provides a flexible 3D pressure sensing device in a textile structure. The force-sensitive component 1 is made from elastic fabric, the main component of which is polyurethane filament yarn mixed with carbon black nanoparticles. Due to the loose porous structure formed by the polyurethane filaments in the textile structure, there may or may not be electrical connections between them, meaning that the effective conductive contact area of the fabric changes with pressure, thus allowing for an overall piezoresistive effect. Moreover, when the pressure increases to a certain extent and the effective conductive contact area inside the fabric becomes basically stable, the polyurethane/carbon black composite material itself is compressed, resulting in a further piezoresistive effect. Therefore, this embodiment adopts a textile structure with piezoresistive effect, which can achieve measurements under small pressure, medium pressure, and large pressure. Buttons are sewn onto the surface of the fabric (i.e. the force-sensitive component 1) to serve as the 3D transmission components 2. These buttons can transmit both pressure and shear force. To enhance the force transmission effect, in some embodiments, the number of sewing points for the buttons can be increased from 2 to multiple sewing points. In some embodiments, the buttons can also be adhered to the elastic fabric of the force-sensitive component 1 using hot melt adhesive or other types of glue. Finally, silver-plated nylon yarn is sewn at each electrode position on the periphery of the conductive fabric of the force-sensitive component 1, serving as the electrodes 3, allowing signals to be led out.

Since Embodiment III is a 3D pressure sensing device completely made of textile and garment materials, the device possesses various characteristics of textiles and garment products, including being soft, porous, breathable, washable, and dryable, as well as having conformability to curved surfaces, etc. Therefore, this device can be easily integrated into smart clothing, robotic garments, or even household textiles, achieving a variety of multi-point 3D pressure detection functions. In addition, since the textile-type force-sensitive component 1 can exhibit piezoresistive effects for small, medium, and large pressures, this sensing device has practical value in applications such as multi-point 3D pressure touch, multi-point collision pressure detection, and even real-time measurement of medium to low-speed impact pressure magnitude and pressure direction.

In some embodiments, methods such as three-dimensional weaving, three-dimensional knitting, and three-dimensional braiding can be employed to prepare the force-sensitive component 1 and the 3D transmission components 2 in a single step, thereby achieving better integration in the manufacturing of the device and the structural integrity of the pressure sensing device.

In some embodiments, the distribution of the electrodes 3 is not necessarily uniformly arranged; the distribution density of the electrodes can be adjusted based on the distribution density of the pressure sensing units and the varying accuracy requirements for pressure sensing information at different positions.

### Embodiment IV

Referring to FIGS. 1A and 1B, this embodiment provides a fully flexible multi-point 3D pressure sensing device. This embodiment differs from Embodiment I in that, the force-sensitive component 1 is made from an electrically conductive hydrogel (such as a hydrogel rich in NaCl), or may be composed of other electrically conductive liquids rich in conductive ions (such as sodium ions, potassium ions, etc.) encapsulated within a silicone rubber plate (with silicone rubber used as a container for the liquid) or formed from liquid metal (such as gallium-indium alloy). Due to the good fluidity of these materials (such as liquid metals) or their very small elastic modulus (for example, electrically conductive hydrogels), they can be very sensitive to very small pressures. When external 3D transmission components 2 (preferably protruding structures made of similar types of hydrogels without electrically conductive materials or silicone protruding structures) are arranged, real-time measurement of weak 3D pressure can be achieved, providing the magnitude and direction of the pressure at each force point.

### Embodiment V

The embodiments described above are all solid structures. Instead, non-solid materials can also be used. Referring to FIGS. 1A and 1B, Embodiment V provides a force-sensitive component 1 constructed from an open-cell sponge sheet layer, in which multi-armed carbon nanotubes are deposited inside the sponge sheet layer, thus endowing the sponge sheet layer with a piezoresistive effect. A surface of the sponge sheet layer also features hemispherical 3D structures formed by foaming, serving as the 3D transmission components 2, as seen in the cross-section of FIG. 1B. Finally, the electrodes 3 are arranged on the periphery of the sponge, and after connecting the wires, real-time measurement of multi-point 3D micro pressure can be achieved using the electrical impedance tomography method.

Besides using foam sponge technology to fill carbon-based electrically conductive nanoparticles, it is also possible to prepare piezoresistive materials with 3D force transmission structures for electrical impedance tomography-enabled 3D pressure sensing devices through methods such as 3D printing.

Based on this, compared to the existing technology, the flexible 3D pressure sensing device of the present disclosure has at least the following beneficial effects:

(1) 3D force: The present disclosure is capable of achieving multifunctional detection of the touch position, the magnitude and direction of the pressure at each touch position, as well as the overall morphology inferred from contact pressure, greatly enhancing the sensing capability of the sensor. In particular, the sensing of 3D forces can provide richer information compared to the sensing of pure normal pressure.

(2) Simple structure and process: Compared with the pressure sensor matrix, the present disclosure adopts an integrated structure, eliminating the need for complex internal microstructures and wiring, thereby reducing manufacturing difficulty and costs.

(3) Flexible and stretchable: The sensor materials are low-cost and flexible, possessing inherent flexibility and stretchability without the use of stretchable wires. It can easily conform to surfaces of diverse irregular 3D objects to reach integrated tactile sensing and full-field coverage, thereby enhancing the applicability and practicality of the sensor.

(4) Textile characteristics: When a flexible 3D force sensing device is made of textile materials, it also possesses various advantages of textiles and garment products, including being skin-friendly, comfortable, breathable, porous, lightweight, machine washable, dryable, etc., thus allowing for perfect integration with various textiles and garment products.

The above is a detailed description of some implementations of the present disclosure, but the present disclosure is not limited to the above-mentioned embodiments. Those of ordinary skill in the art can also make various equivalent modifications or replacements without departing from the gist of the present disclosure, and these equivalent modifications or replacements are all included in the scope defined by the claims of the present disclosure.

What is claimed is:

1. A flexible three-dimensional (3D) pressure sensing device, comprising: a force-sensitive component, a plurality of 3D transmission components, and a plurality of electrodes, wherein the force-sensitive component is composed of a single piece of flexible and electrically conductive material with a piezoresistive property; the plurality of the 3D transmission components are distributed on a surface of the force-sensitive component, and each of the plurality of 3D transmission components is configured to transmit pressure to the force-sensitive component, causing correspondingly a characteristic change in electrical resistance of the force-sensitive component, wherein the pressure comprises a normal pressure and a shear pressure; and the plurality of the electrodes are arranged on a periphery of the force-sensitive component, and each of the electrodes is configured to lead out resistance distribution data of the force-sensitive component through a respective wire, such that a backend circuit device calculates 3D pressure distribution information of the flexible 3D pressure sensing device at each position on the surface at each time point based on the resistance distribution data.

2. The flexible 3D pressure sensing device of claim 1, wherein the force-sensitive component is a solid planar structure or a porous mesh structure.

3. The flexible 3D pressure sensing device of claim 1, wherein the force-sensitive component is made of an electrically conductive composite material, or a liquid metal, or a conductor or semiconductor material rich in a conductive ion, or an assembly of electrically conductive fibers with a piezoresistive property, or an elastomer and an assembly of fibers containing intrinsically conductive polymers.

4. The flexible 3D pressure sensing device of claim 1, wherein each of the plurality of 3D transmission components has a 3D protruding structure, and the plurality of 3D transmission components are uniformly or non-uniformly distributed on the surface of the force-sensitive component, with each 3D transmission component being intimately bonded to the force-sensitive component.

5. The flexible 3D pressure sensing device of claim 1, wherein each of the plurality of electrodes is formed by using a coating or plating of a good conductor of electricity, or a micro-nano structured material, or a carbon-based electrically conductive material, or an intrinsically conductive polymer, or a liquid metal, or an electrically conductive fiber material, with the plurality of electrodes being uniformly or non-uniformly arranged on the periphery of the force-sensitive component.

6. The flexible 3D pressure sensing device of claim 1, wherein an elastic modulus of a material of each of the plurality of 3D transmission components is greater than or equal to that of the force-sensitive component.

7. The flexible 3D pressure sensing device of claim 1, wherein, when materials used for each of the plurality of 3D transmission components and the force-sensitive component are the same, a method of template injection molding or mold imprinting is employed to form a sheet-like elastic electrically conductive material with a 3D protruding structure for each of the plurality of 3D transmission components, and each of the plurality of electrodes and the respective wire are printed at a respective designated position on the periphery of the force-sensitive component.

8. The flexible 3D pressure sensing device of claim 1, wherein, when materials used for at least one of the plurality of 3D transmission components and the force-sensitive component are different, the force-sensitive component is cut or processed to a required size and shape, and fixing the at least one of the plurality of 3D transmission components to the surface of the force-sensitive component is carried out.

9. The flexible 3D pressure sensing device of claim 8, wherein the fixing is carried out by: applying a transmission material to designated positions of the plurality of 3D transmission components via a glue dispensing machine to form the plurality of 3D transmission components, or preparing the plurality of 3D transmission components on the surface of the force-sensitive component via 3D printing technology, or applying each unit of an additional mechanical transmission part to the designated positions on the surface of the force-sensitive component through textile and garment processing techniques.

10. The flexible 3D pressure sensing device of claim 1, wherein a surface of at least one of the plurality of 3D transmission components is covered with an encapsulation layer, and an encapsulation material of the encapsulation layer is a flexible polymer elastomer with a low elastic modulus.
